(19) United States
(12) Patent Application Publication
(10) Pub. No.: US 2010/0077208 A1
(43) Pub. Date: Mar. 25, 2010

(54) CERTIFICATE BASED AUTHENTICATION FOR ONLINE SERVICES

(75) Inventors: Madan R. Appiah, Redmond, WA (US); Murli Dharan Satagopan, Kirkland, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/233,865

(22) Filed: Sep. 19, 2008

(51) Int. Cl. H04L 9/00

(52) U.S. Cl. 713/158; 713/156

(57) ABSTRACT

In one embodiment, a client computer system receives user credentials from a computer user. The client computer system formulates a system identifier that uniquely identifies the system, and sends the received user credentials with the system identifier to an authentication service running on a datacenter server. The authentication service is configured to authenticate the user credentials and generate an authentication certificate based on the user credentials and the system identifier. The client computer system receives the generated authentication certificate from the authentication service and stores the received authentication certificate. The computer system receives an authentication request to authenticate the user subsequent to storing the certificate and, in response to the authentication request, automatically sends the stored authentication certificate to indicate to the datacenter server that the user is authorized to access the datacenter-provided information, without prompting the user to provide user credentials for authentication.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In many cases, software applications are designed to interact with other software applications or other computer systems. For example, a client computer system might connect to a server in a datacenter to access application information. The server may be configured to ask the client for some type of authentication to verify that the client is authorized to access the requested application information. For instance, if a client wants to access email on an email server, the email server may ask the client to supply a username and a password to verify the user's identity.

In some cases, for added security, the identity of the server is also validated by the client. This ensures that the client is connecting to the appropriate application server, and not a different server possibly trying to pose as a legitimate server. By verifying that the server computer system is who it says it is, the client can rest assured that they are not connecting to an unknown server. This is an important feature in a landscape where many computer systems are configured to pose as legitimate clients or servers, when actually they are only the extensions of malicious users.

### BRIEF SUMMARY

Embodiments described herein are directed establishing secure communication between a client computer system and a datacenter server computer system. In one embodiment, a computer system receives user credentials from a computer user. The computer system formulates a client computer system identifier that uniquely identifies the client computer system. The computer system sends the received user credentials and the client computer system identifier to an authentication service running on a server computer in a datacenter. The authentication service is configured to authenticate the user credentials to determine that the user is authorized to access datacenter-provided information corresponding to one or more client-side applications and generate an authentication certificate based on the user credentials and the received client computer system identifier, the certificate being generated for subsequent authentication to datacenter applications.

The computer system receives the generated authentication certificate from the authentication service indicating that the user is authorized to access the datacenter-provided information and stores the received authentication certificate in a store on the client computer. The computer system receives from a datacenter server an authentication request to authenticate the user subsequent to storing the certificate and, in response to the authentication request, automatically sends the stored authentication certificate to indicate to the datacenter server that the user is authorized to access the datacenter-provided information, without prompting the user to provide user credentials for authentication.

In another embodiment, a datacenter computer system receives user credentials and a client computer system identifier from a client-side authentication service, where the datacenter server provides a server-side authentication service, and where the client computer system identifier is formulated to uniquely identify the client computer system. The datacenter computer system causes an authentication certificate to be generated based on the received user credentials and the client computer system identifier, where the certificate indicates to the datacenter server that the user at the specified client system is authorized to access the datacenter-provided information corresponding to user-accessible applications for a limited amount of time.

The computer system sends the generated authentication certificate to the client computer, where the generated certificate includes an expiration stamp identifying when the certificate's validity ends. The computer system receives an information request from a client-side application to access datacenter-provided information corresponding to the client-side application. The information request includes the authentication certificate. In response to the information request, the computer system automatically sends the requested client-side application information without prompting the user to provide user credentials for authentication. The included authentication certificate indicates that the user is authorized to access the requested information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including establishing secure communication between a client computer system and a datacenter server computer system.

FIG. 2 illustrates a flowchart of example methods for establishing secure communication between a client computer system and a datacenter server computer system.

FIG. 3 illustrates an embodiment of the present invention in which client communications are intercepted.

### DETAILED DESCRIPTION

Embodiments described herein are directed establishing secure communication between a client computer system and a datacenter server computer system. In one embodiment, a computer system receives user credentials from a computer user. The computer system formulates a client computer system identifier that uniquely identifies the client computer system. The computer system sends the received user credentials and the client computer system identifier to an authentication service running on a server computer in a datacenter. The authentication service is configured to authenticate the user credentials to determine that the user is authorized to access datacenter-provided information corresponding to one or more client-side applications and generate an authentication certificate based on the user credentials and the received client computer system identifier, the certificate being generated for subsequent authentication to datacenter applications.

The computer system receives the generated authentication certificate from the authentication service indicating that the user is authorized to access the datacenter-provided information and stores the received authentication certificate in a store on the client computer. The computer system receives from a datacenter server an authentication request to authenticate the user subsequent to storing the certificate and, in response to the authentication request, automatically sends the stored authentication certificate to indicate to the datacenter server that the user is authorized to access the datacenter-provided information, without prompting the user to provide user credentials for authentication.

In another embodiment, a datacenter computer system receives user credentials and a client computer system identifier from a client-side authentication service, where the datacenter server provides a server-side authentication service, and where the client computer system identifier is formulated to uniquely identify the client computer system. The datacenter computer system causes an authentication certificate to be generated based on the received user credentials and the client computer system identifier, where the certificate indicates to the datacenter server that the user at the specified client system is authorized to access the datacenter-provided information corresponding to user-accessible applications for a limited amount of time.

The computer system sends the generated authentication certificate to the client computer, where the generated certificate includes an expiration stamp identifying when the certificate's validity ends. The computer system receives an information request from a client-side application to access datacenter-provided information corresponding to the client-side application. The information request includes the authentication certificate. In response to the information request, the computer system automatically sends the requested client-side application information without prompting the user to provide user credentials for authentication. The included authentication certificate indicates that the user is authorized to access the requested information.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media including recordable-type storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

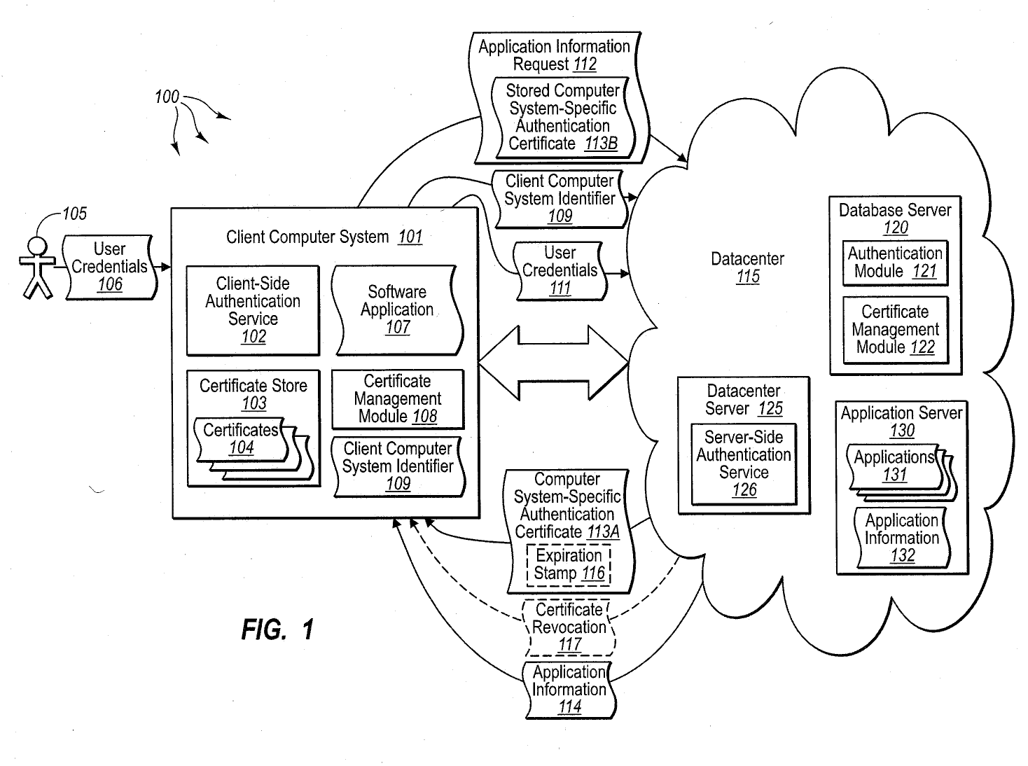

FIG. 1 illustrates a computer architecture 100 in which the principles of the present invention may be employed. Computer architecture 100 includes client computer system 101. Client computer system 101 may be any type of computer system, mobile or stationary, wired or wirelessly linked to datacenter 115 or any other computer systems (e.g. via the internet). Client computer system 101 (hereinafter system 101 or client system 101) includes client-side authentication service 102. Service 102 may be configured to receive user credentials 106 from user 105. User 105 may be any type of computer user including an end-user, developer, administrator or other user. User credentials 106 may be any identifier or other element used to identify and/or authenticate user 105. Such elements may include, for example, username, password, biometric indicators, key codes, or any other item usable to identify user. 105.

Client-side authentication service 102 may be used to authenticate user 105 to another server or servers. For example, when client 105 provides credentials 106 to service 102, service 102 may be configured to send the user credentials 111 to datacenter 115. User credentials 111 may be the same as credentials 106, or they may be the processed result of an encryption or signing algorithm applied to credentials 106. Moreover, credentials 106 may be stored in a credential store, and later retrieved and sent to datacenter 115 as credentials 111. In some embodiments, client-side authentication service 102 may be installed on computer system 101 as a stand-alone application, installed with another program as part of that program, or may be installed as a plug-in to an existing application. Service 102 may optionally run as an applet inside a browser or other software application.

As used herein, client-side authentication service 102 may be referred to as a single sign-on service. For instance, user 105 may be able to sign in (i.e. authenticate) using service 102 and from that single authentication, be able to access multiple applications that would otherwise individually prompt the user to supply sign-on credentials. For example, user 105 may be using software application 107. During operation, application 107 may need to access information stored on a server (e.g. application server 130 in datacenter 115). As will be explained in greater detail below, the application may be able to access the appropriate information stored on the server and deliver the information to the client without prompting the client for login credentials.

Client computer system 101 may also be configured to send client computer system identifier 109 to datacenter 115. Client computer system identifier 109 may be any type of informational element used to identify client computer system 101. For example, identifier 109 may include a hard drive serial number, media access control (MAC) address, operating system type, internet protocol (IP) address, computer system serial number, or other identifying information that could be used to uniquely identify the client computer system. Using such an identifier may be advantageous in that datacenter 115 is assured that the communications are coming from user 105 and not from another (possibly malicious) user (e.g. a “man in the middle”). As used herein, a man in the middle may be any computer system or software application designed to intercept client/server communications and present itself as a legitimate user.

Client computer system 101 may also include certificate management module 108. Credential management module 108 may be configured to access certificates 104 stored in certificate store 103. Certificates, such as computer system-specific authentication certificate 113A, may be generated by one of the datacenter servers using user credentials 111 and client computer system identifier 109. Thus, the certificates may be system specific such that they are only valid for a single computer system.

As illustrated in FIG. 1, datacenter 115 may include database server 120, datacenter server 125 and application server 130. It should be noted that datacenter 115 may include any number of server computer systems and may include less or more than those servers shown in FIG. 1. In some embodiments, datacenter 115 may comprise a single server configured to perform all the functionality of a database server, a datacenter server and an application server. In other cases, multiple servers (possibly located in multiple, different locations) may be part of datacenter 115.

Datacenter server 125 may be configured to act as a gateway server that monitors some or all of the network traffic coming in to the datacenter. Server 125 includes server-side authentication service 126. As indicated above with regard to the datacenter, service 126 may be provided by any computer in datacenter 115. Server-side authentication service 126 may be a corollary service to client-side authentication service 102. That is, service 102 may communicate with service 126 to authenticate user 105 to the servers of datacenter 115. Upon receiving client credentials 111, datacenter server 125 may be configured to communicate with database server 120 (specifically authentication module 121) to determine whether user 105 is authorized to access at least some information in datacenter 115. Authentication module 121 may perform a search to determine which servers, shares and/or applications client 105 has access to in the datacenter. Authentication module 121 can then generate authorization indication 113, indicating that user 105 is authorized to access at least some information in datacenter 115. Certificate management module 122 may add information or policies to authorization certificate 113A such as password policies, expiration stamps, or other information which can be interpreted and processed by certificate management module 108 on client system 101.

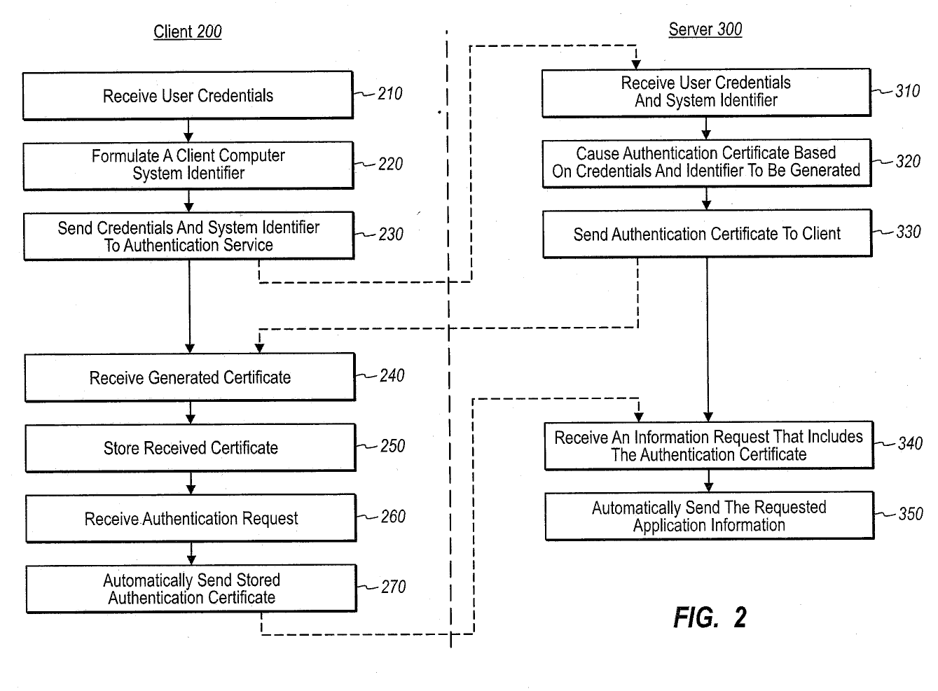

Application server 130 provides access to applications 131 and/or application information 132. In some cases, user 105 may wish to access an application provided entirely (or substantially so) by application server 130. In other cases, the application may be initiated by the client on system 101 (e.g. application 107) and may only use portions of information 132 provided by server 130. For instance, application 107 may be an email/calendaring program. The email program may be configured to access a server to download and upload the client's email and calendar updates. This and other aspects of the invention will be explained in greater detail below with regard to FIG. 2.

FIG. 2 illustrates a flowchart of methods 200 and 300 for establishing secure communication between the client computer system and the datacenter server computer systems, from the client perspective and the server perspective, respectively. The methods 200 and 300 will now be described with frequent reference to the components and data of environment 100.

It should be noted that, while the acts of methods 200 and 300 are depicted as occurring in the order illustrated in FIG. 2, the acts may be performed in substantially any order and may be performed out of order without the occurrence of other acts.

Method 200 includes an act of receiving at a client computer one or more user credentials from a computer user (act 210). For example, client system 101 may receive user credentials 106 from user 105. Credentials 106 may be received as part of an operating system login, or after the user is prompted to sign in to authentication service 102. For instance, in cases where service 102 is installed on system 101, service 102 may prompt the user to enter user credentials for authentication to datacenter 115. In some cases, client 105 may indicate a desire to access a software application that is either provided by application server 130 or uses information provided by application server 130. Upon receiving this indication, system 101 may prompt user 105 to install service 102 if it is not already installed on the user's computer system.

Method 200 includes an act of formulating a client computer system identifier that uniquely identifies the client computer system (act 220). For example, computer system 101 may formulate client computer system identifier 109 that uniquely identifies client computer system 101. As mentioned above, identifier may be formulated, based on or derived from any number of different numbers or other information elements that are associated with or specifically identify client system 101. For example, identifier 109 may simply correspond to a MAC or IP address, or may be generated based on a combination of multiple informational elements such as operating system type, MAC address and hard drive serial number. It will be appreciated that any number or combination of informational elements may be used to formulate identifier 109.

Method 200 includes an act of sending the received user credentials and the client computer system identifier to an authentication service running on at least one server computer in a datacenter, the authentication service being configured to authenticate the user credentials to determine that the user is authorized to access datacenter-provided information corresponding to one or more client-side applications and generate an authentication certificate based on the user credentials and the received client computer system identifier, the certificate being generated for subsequent authentication to datacenter applications (act 230). For example, client system 101 may send user credentials 111 and formulated client computer system identifier 109 to server side authentication service 126 running on datacenter server 125. Authentication service 126 may be configured to authenticate user credentials 111 to determine that user 105 is authorized to access application information 132 corresponding to software application 107. Furthermore, authentication service 126 may be configured to generate computer system-specific authentication certificate 113A based on user credentials 111 and identifier 109. Certificate 113A may be used for authenticating user 105 and system 101 to datacenter 115 such that user 105 can access applications and application information provided by the datacenter.

In some cases, access to datacenter-provided information 132 is based solely on validation of the authentication certificate. For example, as will be explained further below, certificate 113A may be stored in certificate store 103 and, upon request, may be sent to datacenter 115 to authenticate user 105 and system 101. Certificate 113A may be issued with limitations such as expiration stamps, or other indications that the certificate has limited validity. For example, certificate may only be valid for a relatively short amount of time to ensure that even if the certificate were somehow misappropriated, the certificate's validity would soon expire (e.g. as indicated by expiration stamp 116). Certificates may also be revoked at any time by any of the datacenter 115 servers. For instance, certificate revocation indication 117 may be sent to client system 101 indicating that one or more stored certificates 104 has been revoked and is no longer valid. In some cases, upon receiving such a revocation indication, the revoked certificates may be deleted from store 103.

Method 300 includes an act of receiving at a datacenter server computer one or more user credentials and a client computer system identifier from a client-side authentication service, the datacenter server providing a server-side authentication service, the client computer system identifier being formulated to uniquely identify the client computer system (act 310). For example, datacenter server 125 may receive user credentials 111 and client computer system identifier 109 from client-side authentication service 102. Datacenter server 125 may provide a corresponding server-side authentication service 126 used to authenticate user 105 and system 101. In some cases, server 125 may delegate the actual authentication to another computer in the datacenter such as authentication module 121 on database server 120.

Method 300 includes an act of causing an authentication certificate to be generated based on the received user credentials and the client computer system identifier, the certificate indicating to the datacenter server that the user at the specified client system is authorized to access the datacenter-provided information corresponding to one or more user-accessible applications for a limited amount of time (act 320). For example, datacenter server 125 may cause client system-specific authentication certificate 113A to be generated based on user credentials 111 and system identifier 109. Certificate 113A may be used to indicate to datacenter servers that user 105 at client system 101 is authorized to access application information 114, at least until the validity period of the certificate has expired or the certificate has been revoked.

Method 300 includes an act of sending the generated authentication certificate to the client computer, the generated certificate including an expiration stamp identifying when the certificate's validity ends (act 330). For example, datacenter server 125 may send certificate 113A to client computer 101, where certificate 113A includes expiration stamp 116 identifying when the certificate's validity ends. In some cases, it may be advantageous to perform mutual authentication between client system 101 and server 125. For instance, server 125 may send a server authentication certificate to client system 101 identifying the server as being a validated server. Moreover, server 125 may receive from client system 101 an indication indicating that the client has validated the server authentication certificate and identified the server as being a valid datacenter server. In some cases, the secure connection established between the datacenter server and the client is a mutual secure sockets layer (SSL) authentication.

Method 200 includes an act of receiving the generated authentication certificate from the authentication service indicating that the user is authorized to access the datacenter-provided information (act 240). For example, client system 101 may receive generated authentication certificate 113A from server-side authentication service 126 indicating that user 105 is authorized to access those datacenter-provided applications and/or application information for which the user has rights. For example, although user 105 may be generally authorized to access datacenter-provided information, there may still be data portions to which only super users or computer administrators have access. Similarly, in a role-based system, the user may be granted access rights according to his or her assigned role.

Method 200 includes an act of storing the received authentication certificate in a store on the client computer (act 250). For example, client system 101 may store authentication certificate 113A in certificate store 103. Store 103 may be configured to store multiple authentication certificates 104 corresponding to different users, or for certificates granting different rights or for certificates having different expirations or policies. Certificate management module 108 may be configured to search among the stored certificates for expired certificates. Expired certificates may and be automatically (or manually) discarded. Certificate management module 108 may also be configured to automatically select an appropriate certificate from among the plurality of certificates when a certificate is needed for authentication to datacenter 115.

Method 200 includes an act of receiving from a datacenter server an authentication request to authenticate the user subsequent to storing the certificate (act 260). For example, client computer system 101 may receive from datacenter server 125 an authentication request indicating that in order to access application information 114, user 105 is to be authenticated to datacenter 115. In some cases, such an authentication request may be received in response to client system 101 sending application information request 112. In some embodiments, stored computer system-specific authentication certificate 113B may be sent along with application information request 112, thus eliminating any need for datacenter server 125 to send a request for authentication information.

Method 200 includes an act of automatically sending the stored authentication certificate to indicate to the datacenter server that the user is authorized to access the datacenter-provided information in response to the authentication request, without prompting the user to provide user credentials for authentication (act 270). For example, client system 101 may automatically send stored authentication certificate 113B to server 125 to indicate to server 125 that user 105 is authorized to access either or both of applications 131 and application information 132.

Method 300 includes an act of receiving an information request from a client-side application to access datacenter-provided information corresponding to the client-side application, the information request including the authentication certificate (act 340). For example, datacenter server 125 may receive application information request 112 from software application 107 to access application information 132 corresponding to application 107. In some embodiments, request 112 may include authentication certificate 113B indicating that the client is authorized to access the information they are requesting. In some cases, if server 125 determines that no authentication certificate was received from client system 101, server 125 may send an indication to client system 101 indicating that access to the information is denied. Such an indication may also provide an opportunity for client system 101 to (again) send an authorization certificate.

In some embodiments, client computer system may determine that authentication certificate 113A is set to expire automatically after a specified time period or determine that the specified expiration time period has expired. In response, certificate management module 108 may the revoked certificate from certificate store 103 on client computer 101.

Method 300 includes an act of automatically sending the requested client-side application information without prompting the user to provide user credentials for authentication in response to the information request, the included authentication certificate indicating that the user is authorized to access the requested information (act 350). For example, application server 130 may automatically send application information 114 without prompting user 105 to provide user credentials for authentication in response to information request 112. Certificate 113, because it is based on user credentials 111 and identifier 109, can indicate to datacenter 115 that user 105 is authorized to access information 132 without prompting the user for login credentials. Moreover, certificate 113 may be subsequently used in further application information requests to avoid the need to login again using user credentials 111.

Datacenter servers may be further configured to determine that user 105 has logged off of client-side authentication service 102. In response, datacenter servers may revoke the authentication certificate, such that the certificate is no longer valid. Similarly, when any of the datacenter servers determine that the specified limited amount of time for certificate validity has expired, any issued certificates with expired time stamps may be revoked, such that the certificate is no longer valid.

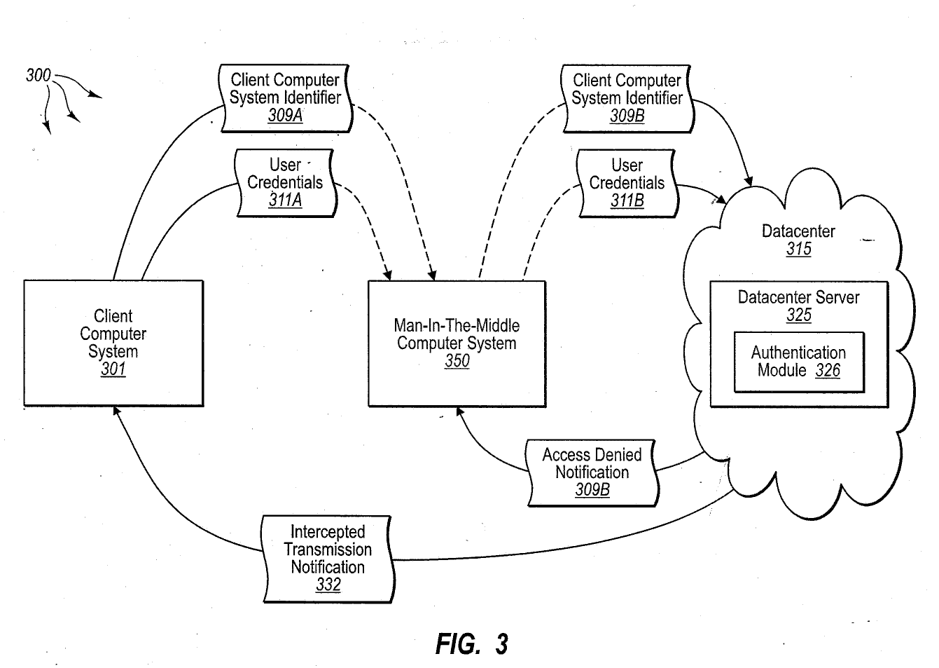

In one embodiment, as illustrated in FIG. 3, user credentials 311 A and/or client computer system identifier 309A sent from client computer system 301 may be intercepted by man-in-the-middle computer system 350. System 350 may then attempt to send identifier 309B and/or credentials 311B hoping to pass them off as being from client system 301. Datacenter server 325 in datacenter 115 may attempt to authenticate computer system 350 using identifier 309B and credentials 311B. However, because client computer system identifier 309B does not correspond to man-in-the-middle computer system 350, authentication module 326 will determine that the communication from user 305 has been intercepted and that the interceptor is to be denied access to any datacenter-provided information. Accordingly, access denied notification 331 may be sent to man-in-the-middle system 350. Additionally or alternatively, an intercepted transmission notification 332 may be sent to client computer system 301 to notify the user that communication between the client and server is not secure and that the client has not been authenticated.

Accordingly, implementation of a client computer system identifier that uniquely identifies the client computer system may be implemented to ensure that communication between a client and server is secure and that when access is granted to a user on a client computer system, the server can be sure that no other computer systems have intercepted the client computer's communications.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a computer networking environment including at least a client computer system and a datacenter comprising a plurality of server computer systems, a method for establishing secure communication between the client computer system and the datacenter server computer systems, the method comprising:
an act of a client computer receiving one or more user credentials from a computer user;
an act of formulating a client computer system identifier that uniquely identifies the client computer system;
an act of sending the received user credentials and the client computer system identifier to an authentication service running on at least one server computer in a datacenter, the authentication service being configured to:
authenticate the user credentials to determine that the user is authorized to access datacenter-provided information corresponding to one or more client-side applications; and
generate an authentication certificate based on the user credentials and the received client computer system identifier, the certificate being generated for subsequent authentication to datacenter applications;
an act of receiving the generated authentication certificate from the authentication service indicating that the user is authorized to access the datacenter-provided information;
an act of storing the received authentication certificate in a store on the client computer;
an act of receiving from a datacenter server an authentication request to authenticate the user subsequent to storing the certificate; and
in response to the authentication request, an act of automatically sending the stored authentication certificate to indicate to the datacenter server that the user is authorized to access the datacenter-provided information, without prompting the user to provide user credentials for authentication.

2. The method of claim 1, wherein access to the datacenter-provided information is based solely on validation of the authentication certificate.

3. The method of claim 1, wherein the authentication certificate is revocable at any time by the server.

4. The method of claim 3, further comprising:
an act of receiving from the datacenter an indication that the authentication certificate has been revoked; and
an act of removing the revoked certificate from the store on the client computer.

5. The method of claim 1, further comprising:
an act of determining that the authentication certificate is set to expire automatically after a specified time period;
an act of determining that the specified expiration time period has expired; and
an act of removing the revoked certificate from the store on the client computer.

6. The method of claim 1, wherein the store includes a plurality of stored authentication certificates.

7. The method of claim 6, further comprising an act of automatically selecting an appropriate certificate from among the plurality of certificates.

8. The method of claim 6, further comprising:
an act of searching the plurality of authentication certificates for expired certificates; and
an act of automatically discarding any expired certificates.

9. The method of claim 1, wherein an authentication indication is received at the client computer, the authentication indication being generated based on the sent user credentials.

10. The method of claim 9, wherein, upon receiving from a datacenter server an authentication request to authenticate the user, the received authentication indication is sent along with the authentication certificate.

11. The method of claim 1, wherein the client computer system is running a single sign-on authentication service.

12. In a computer networking environment including at least a client computer system and a datacenter comprising a plurality of server computer systems, a method for establishing secure communication between the client computer system and the datacenter server computer systems, the method comprising:
an act of receiving at a datacenter server computer one or more user credentials and a client computer system identifier from a client-side authentication service, the datacenter server providing a server-side authentication service, the client computer system identifier being formulated to uniquely identify the client computer system;
an act of causing an authentication certificate to be generated based on the received user credentials and the client computer system identifier, the certificate indicating to the datacenter server that the user at the specified client system is authorized to access the datacenter-provided information corresponding to one or more user-accessible applications for a limited amount of time;
an act of sending the generated authentication certificate to the client computer, the generated certificate including an expiration stamp identifying when the certificate's validity ends;
an act of receiving an information request from a client-side application to access datacenter-provided information corresponding to the client-side application, the information request including the authentication certificate; and
in response to the information request, an act of automatically sending the requested client-side application information without prompting the user to provide user credentials for authentication, the included authentication certificate indicating that the user is authorized to access the requested information.

13. The method of claim 12, further comprising an act of sending a server authentication certificate to the client identifying the server as being a validated server.

14. The method of claim 13, further comprising an act of receiving from the client an indication indicating that the client has validated the server authentication certificate and identified the server as being a valid datacenter server.

15. The method of claim 12, further comprising, upon determining that no authentication certificate was received from the client, an act of indicating to the client that access to the application information is denied.

16. The method of claim 12, wherein the requested client-side application information is sent to the client without prompting the user to provide user credentials for authentication as the information request includes both the authentication certificate and valid user credentials.

17. The method of claim 12, further comprising, upon determining that the client has logged off of the client-side authentication service, an act of revoking the authentication certificate, such that the certificate is no longer valid.

18. The method of claim 12, further comprising, upon determining that the specified limited amount of time for certificate validity has expired, an act of revoking the authentication certificate, such that the certificate is no longer valid.

19. The method of claim 14, wherein the secure connection established between the datacenter server and the client comprises a mutual SSL authentication.

20. A computer system comprising the following:
one or more processors;
system memory;
one or more computer-readable storage media having thereon computer-executable instructions that, when executed by the one or more processors, causes the computing system to perform a method establishing secure communication between the client computer system and the datacenter server computer systems, the method comprising the following:
an act of receiving at a datacenter server computer one or more user credentials and a client computer system identifier from a client-side authentication service, the datacenter server providing a server-side authentication service, the client computer system identifier being formulated to uniquely identify the client computer system;
an act of generating an authentication certificate based on the received user credentials and the client computer system identifier, the certificate indicating to the datacenter server that the user at the specified client system is authorized to access the datacenter-provided information corresponding to one or more user-accessible applications for a limited amount of time;
an act of appending a time stamp to the generated authentication certificate such that the certificate is configured to expire or can be revoked upon reaching the time designated in the time stamp;
an act of sending the generated authentication certificate to the client computer;
an act of receiving an information request from a client-side application to access datacenter-provided information corresponding to the client-side application, the information request including the authentication certificate;
in response to the information request, an act of automatically sending the requested client-side application information without prompting the user to provide user credentials for authentication, the included authentication certificate indicating that the user is authorized to access the requested information;
an act of determining that the user has logged off a client-side authentication service or that the certificate has expired based on the time stamp; and
an act of revoking the authentication certificate, such that the certificate is no longer valid.
